(19) United States
(12) Patent Application Publication
(10) Pub. No.: US 2019/0267821 A1
(43) Pub. Date: Aug. 29, 2019

(54) LED LIGHT HAVING ADDED-ON OR BUILT-IN ARRANGEMENT TO HOLD WIRES AND PREVENT THEM FROM DANGLING

(71) Applicant: Tseng-Lu Chien, Walnut, CA (US)

(72) Inventor: Tseng-Lu Chien, Walnut, CA (US)

(21) Appl. No.: 16/389,059

(22) Filed: Apr. 19, 2019

Related U.S. Application Data
(62) Division of application No. 13/858,604, filed on Apr. 8, 2013, now abandoned.
Application No. 13/858,604 is a continuation-in-part of application No. 16/285,631, filed on Feb. 26, 2019.
Application No. 16/285,631 is a continuation-in-part of application No. 16/242,761, filed on Jan. 8, 2019.
Application No. 16/242,761 is a continuation-in-part of application No. 14/739,397, filed on Jun. 15, 2015, now Pat. No. 10,184,624.
Application No. 14/739,397 is a continuation of application No. 11/806,285, filed on May 31, 2007.
Application No. 16/242,761 is a continuation-in-part of application No. 14/739,666, filed on Jun. 15, 2015.
Application No. 14/739,666 is a continuation-in-part of application No. 14/739,499, filed on Jun. 15, 2015.

(51) Int. Cl. H02J 7/00; H01R 13/72

(52) U.S. Cl. CPC H02J 7/0042; H01R 13/72; H01R 31/065; H02J 2007/0062; H02J 7/0052

(57) ABSTRACT

A wire arrangement for USB charger related products enables a wire to be neatly coiled around the USB charger related product and held in place to eliminate messy dangling wires. The wire arrangement can be a separate piece or built-in to the USB charger related product.

### BACKGROUND OF THE INVENTION

The current invention has subject matter in common with the LED devices disclosed in the inventor's U.S. patent application Ser. Nos. 12/950,017, filed Nov. 19, 2010 (“Rotating LED light device has outlets or electric receiving sockets means”); 13/117,227, filed May 27, 2011 (“Electric device has build in Universal USB-unit(s) and Outlet-unit(s)”); 13/161,643, filed Jun. 16, 2011 (“Desk Top LED device has USB-unit(s) or Outlet-Unit(s) to charge electric or digital device”); and 11/806,285, filed May 31, 2007 (“Multiple Function LED night light”).Additional related subject matter, including (1) projection lights, (2) light devices with more than one function, (3) adjustable focus devices, (4) adjustable angle devices, (5) elastic contact points, (6) LED heat solutions, (7) heat sensitive parts installation, and (8) extend means are disclosed in the inventor's U.S. patent application Ser. Nos.: 13/367,758, 13/367,687, 13/296,508, 13/295,301, 13/021,107, 12/950,017, 12/938,564, 12/886,832, 12/876,507, 12/771,003, 13/021,124, 12/624,621, 12/622,000, 12/318,470, 12/914,584, 12/834,435, 12/292,153, 12/907,443, 12/232,505, 11/806,711, and 11/806,285.

The current invention also has subject matter in common with the lamp holders with digital data devices and multiple surface LED lights disclosed in the inventor's U.S. patent application Ser. Nos. 13/295,301, 13/296,508, 13/296,460, 12/951,501, and 12/950,017, as well as the devices disclosed in the inventor's U.S. patent application Ser. Nos. 13/162,824, 12/938,628, 12/887,700, 12/149,963 (now U.S. Pat. No. 7,722,230), Ser. No. 12/073,095 (now U.S. Pat. No. 7,726,869), Ser. Nos. 12/073,889, 12/007,076 (now U.S. Pat. No. 7,726,841), Ser. No. 12/003,691 (now U.S. Pat. No. 7,726,839), and Ser. No. 12/894,865.

Still further devices having features that may be utilized in the present invention include those disclosed in the inventor's U.S. patent application Ser. Nos. 12/624,621, 12/622,100, 12/318,471, 12/318,470, 12/318,473, 12/292,153, 12/232,505, 12/232,035, 12/149,963, 12/149,964, 12/073,095, 12/073,889, 12/007,076, 12/003,691, 12/003,809, 11/806,711, 11/806,285, 11/806,284, 11/566,322, 11/527,628, 11,527,629, 11/498,874, 12/545,992, 12/806,711, 12/806,285, 12/806,284, 12/566,322, 12/527,628, 12/527,629, 12/527,631, 12/502,661, 11/498,881, 11/255,981, 11/184,771, 11/152,063, 11/094,215, 11/092,742, 11/092,741, 11/094,156, 11/094,155, 10/954,189, 10/902,123, 10/883,719, 10/883,747, 10/341,519, 12/545,992, 12/292,580, 12/710,918, 12/624,621, 12/622,000, 12/318,471, 12/318,470, 12/318,473, 12/292,153, 12/710,561, 12/710,918, 12/711,456, and 12/771,003.

The current invention may incorporates features disclosed in any of the above-listed copending or patented cases without departing from the scope of the current invention, which encompasses all related equivalent functions and replacement parts.

### BRIEF DESCRIPTION OF THE DRAWINGS:

FIG. 1 shows a first embodiment of a wire arrangement for a USB charger or USB charger related product, in which add-on wire arrangement means are installed on the USB charger, which has two USB ports and foldable prongs,

FIGS. 2-5 show second to fifth embodiments of an add-on wire arrangement or managing means made up of soft and elastic material or other preferred materials so as to be easily installed, wrapped around, or added to an inner USB charger or USB charger related product to neatly organize all kinds of wires during charging, carrying, or travel.

FIGS. 6A to 6C show a fifth embodiment of the add-on wire arrangement means which is made of more than one piece assembled together to form a space or gap to accommodate a wire, or multiple different wires, with holding means to fix at least part of the wire, a charging plug or a USB plug in position.

FIGS. 7 and 8 show sixth and seventh embodiments having parts that form a space or gap dimensioned according to simple physics and mechanical theory to retract and release the wire arrangement by twisting the top cover, and in which the inner USB charger either already has its own safety certification, as shown in FIG. 7, so that the arrangement of FIG. 7 provides a universal add-on wire arrangement for which there is no need to submit all construction parts to safety authorities for testing, or the inner USB charger has a built-in wire arrangement means designed together with all other construction parts to pass safety tests, as shown in FIG. 8.

FIG. 9 shows an eighth embodiment similar that of FIG. 8 in that it has a built-in wire arrangement means.

FIGS. 10A to 1 OR show a variety of different USB chargers and USB charger-related products for combination with add-on or built-in wire arrangements. The terms USB charger or USB charger related products refer to products having at least one USB charger incorporated with any combination of devices including devices selected from USB charger devices, outlet devices, LED light devices, timepiece devices, motion sensor devices, remote control devices, smell devices, motion devices, animation devices, audio devices, video devices, Internet devices, digital data devices or other electric or electronic devices available from the marketplace to become more functional products.

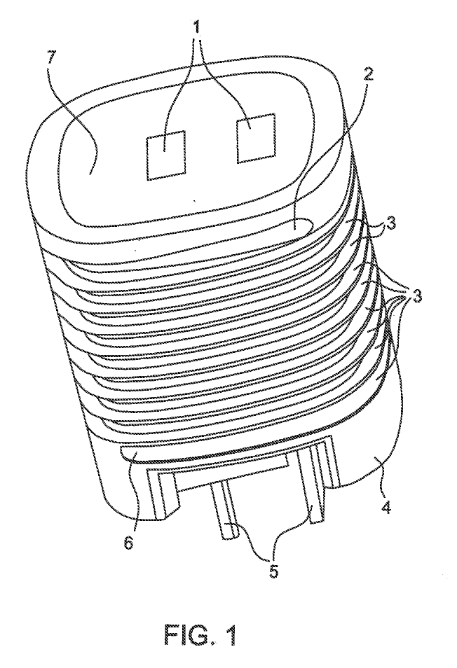

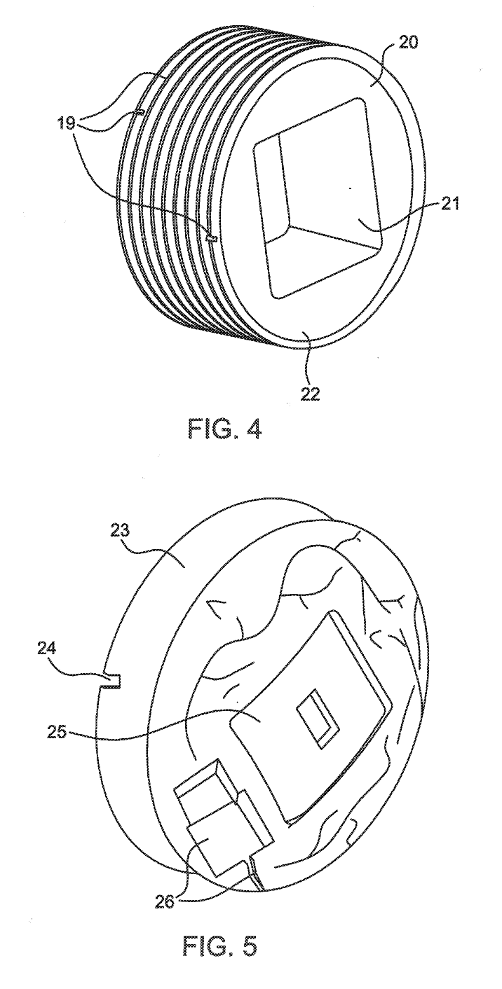

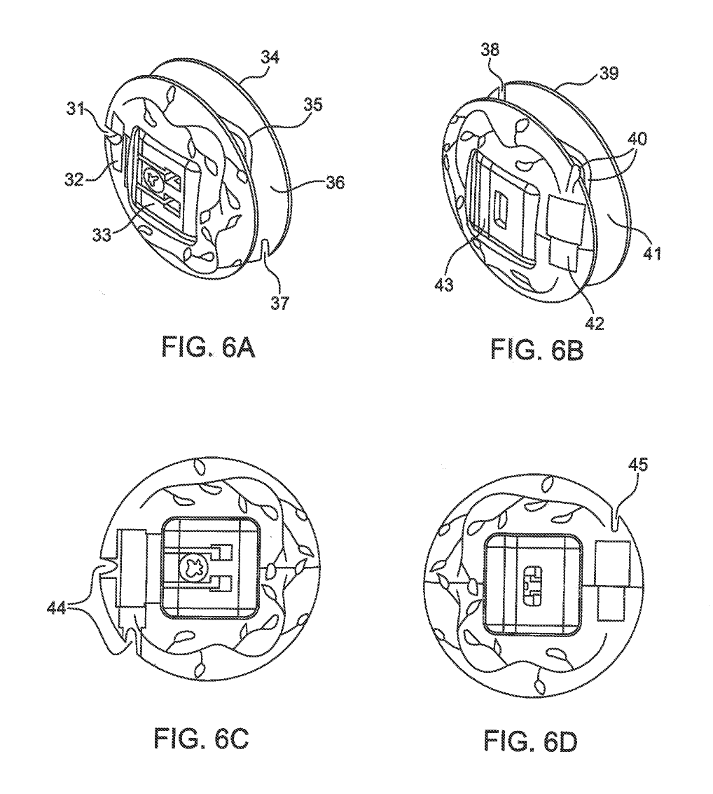

FIGS. 1 to 10 illustrate concepts of the current invention. However, it is to be appreciated that any similar concept or equivalent application having a same purpose or utilizing a same physics theory may still fall within the scope of the present invention without any limitation.

### DETAILED DESCRIPTION OF THE PREFERRED EMBODIMENTS:

FIG. 1 shows a wire arrangement means 3 in the form of a groove, ditch, channel, or cut-outs to allow the wire to fit within and keep the wire neatly arranged on an add-on piece 4 of a safety approved USB charger 7 or other USB charger related product that has been tested by UL or other laboratories and meets all USA safety standard requirements.

The USB charger 7 or USB charger related product may have any size, shape, and have one or more functions, which may be any combination of functions selected from a USB charger, LED light device, motion sensor device, remote control device, audio device, video device, Internet device, digital data transmission device, or other market available electric or electronic device.

The USB charger's ports 1 may include any number from 1 to N, N being any number. The receiving ports may include ports not only for receiving a USB plug, but also an outlet plug, sound plug, video plug, or other market-available plug having electric functions.

The add-on wire arrangement means includes an optional wire input-end holder 6 and an optional wire-output end holder 2, with at least one of the holders holding a wire of the USB plug to be inserted into one of the ports 1 or other wires, depending on market requirements.

The add-on piece 4 may be separated from the USB Charger 7 or USB charger related product so as to allow people to remove or replace it as needed. However, although illustrated as an add-on piece 4, the wire arrangement may also be built-into the charger 7 or charger related product.

The USB Charger or USB Charger related product may have foldable prongs 5 to connect with wall outlets to provide power to the USB charger or USB charger related product circuitry and then supply the power to another device(s) plugged into the port(s) 1.

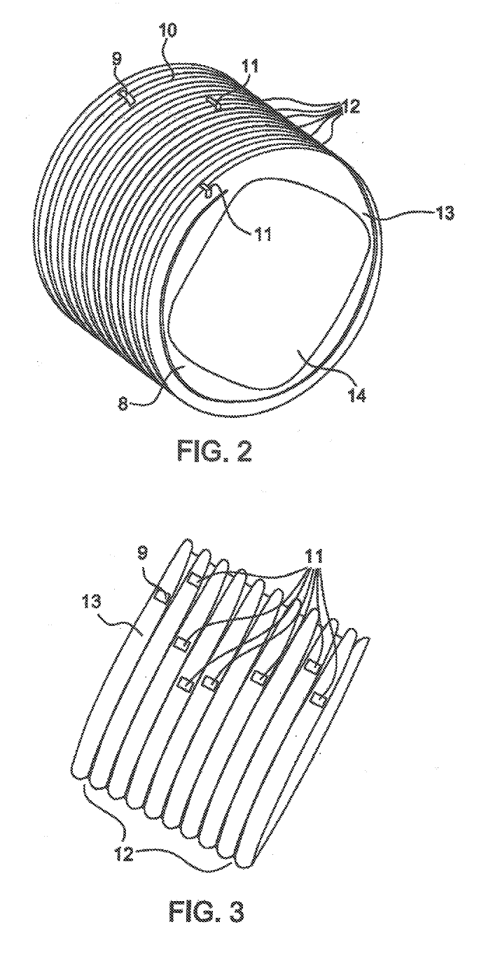

FIG. 2, also shows an add-on or built-in wire arrangement means 13 having a groove, ditch, channel, or cut-outs 12 to neatly arrange wires by fitting them within. More than one groove, ditch, channel, or cut-out may be provided and the grooves, ditches, channels, or cut-outs can be located anywhere on the add-on piece 8 to allow people to install a wire at a desired position and leave the charger-plug or the USB-plug with a preferred wire length hanging out for easier use. The add-on piece 8 includes an interior hollow space 14 for receiving a USB charger or USB charger related product (not shown).

Wire holder receiving openings 9 and 11 for the wire input-end or output-end can be anywhere along the length of the groove, ditch, channel 12 to let people fit the wires as they like for certain arrangements, without requiring that only whole wires be coiled or released. By providing many accurate wire holders, more combinations of wire arrangements can be accommodated on the USB charger or USB charger related product.

Furthermore, the grooves, ditches, channels, or cut-outs of FIGS. 2-4 are all preferably made of soft and elastic material such as silicone, rubber or any other soft material to allow people to easily put the wires into the grooves, ditches, channels, or cutouts. The preferred grooves, ditches, channels, or cutouts have a width that is a little narrower than a wire's diameter so that the wire can easily be pressed into a corresponding groove, ditch, channel, or cut-out to help hold the wire at a desired location. The depth of the grooves, ditches, channels, or cut-outs is preferably bigger than a wire's diameter so the whole diameter of the wire will fit within the depth of the wire arrangement means to protect the wire from scratches, heat, fire, UV, or other damage.

The inner hollow space of the add-on wire arrangement means allows the USB charger or USB charger related products to fit within by physical fitting or equipment during mass production.

The preferred construction for the groove, ditch, channel, or cut-outs is a screw-thread which extends from input-end to output-end in one continuously smooth linear path so as to allow the wire to be easily coiled and release without cross walls and making a mess.

The ditch, groove, channel, or cut-out that holds the wire is well designed on the add-on piece or built-in piece to allow the wire's input-end and output-end to be easily positioned so as not to interfere with operation of the USB plug and charger plug, the ditch, groove, channel, or cut-out having a diameter narrower than the wire's diameter so as to hold the wire tightly anywhere along the ditch, groove, channel, or cut-out and thereby fit different lengths of wire.

A bigger size of the add-on soft elastic wire arrangement means is needed for the smaller or shallower (not thick enough) size of current safety approved USB charger or USB charger related products. Because the circumference of the small USB charger or USB charger related products is not enough to coil a full length of the wire, the circumference of the add-on wire arrangement means needs to be enlarged to have enough room for the groove, channel, ditch, or cutout to accommodate all wires, including not only USB charger wires but also audio, video, Internet, and/or digital data transmitting wires. This is the main feature shown in FIG. 4.

When the USB charger or USB charger related product has a good thickness or bigger circumference to allow all wires to be coiled or arranged within, the add-on or built-in arrangement means can just follow the USB charger's or USB charger related product's contour shape with some added wall thickness and depth of the groove, ditch, channel, or cut-out that serves as the wire holder means. This is main feature shown on the FIG. 4.

FIGS. 5, 6-1, 6-2, 6-3, and 6-4 show wire holder means made up of several parts to form a gap or space to allow a wire to fit within, and further including several appropriately-shaped plug-receiving recesses or compartments to hold a charger plug or USB plug and wire extending therefrom in position. This kind of construction involving a plurality of parts assembled together is not as simple as the soft elastic material arrangement means shown in FIGS. 1, 2, 3, and 4 but has more features and also can receive and position a plug to provide a more high-end application of the current invention.

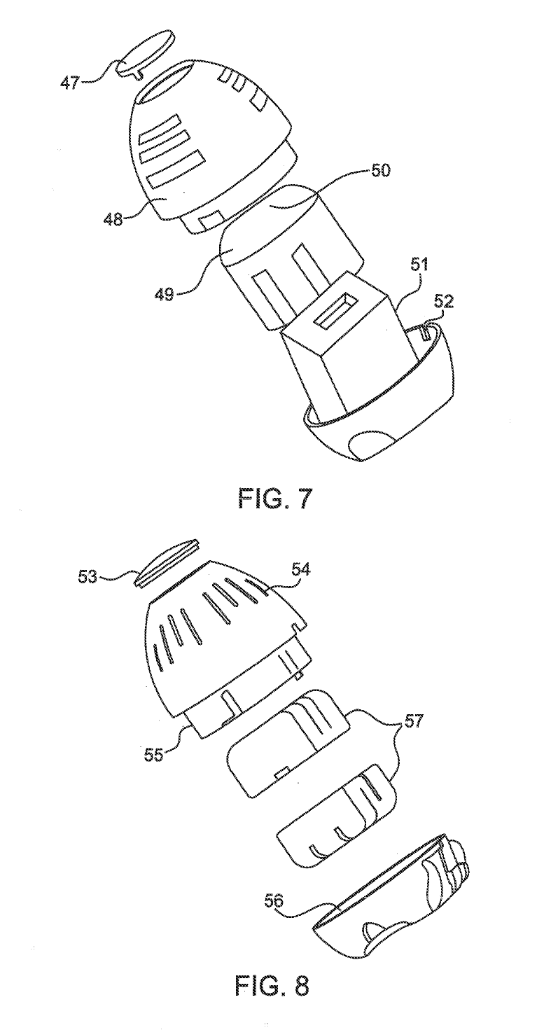

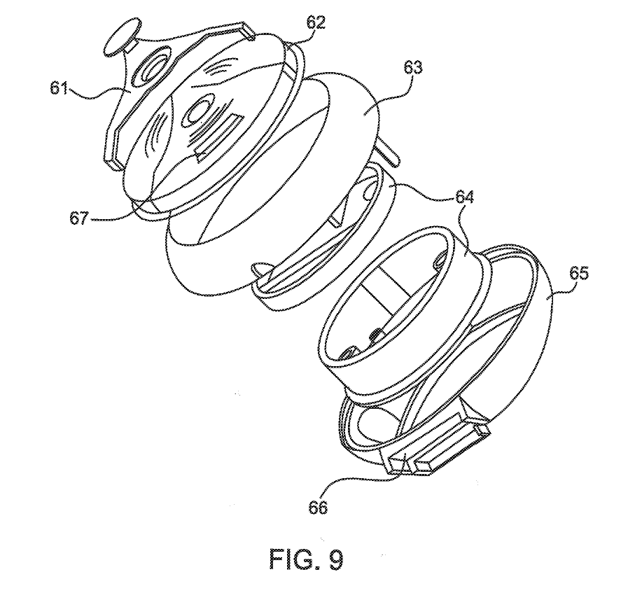

FIGS. 7-9 all show add-on pieces in the form of deluxe models that offer consumers more design and more convenient operation to coil or release wires by rotating the top cover. During the first installation (if the product is not sold with a USB-charger wire), the consumer just needs to make a one-time setting, after which coiling or release of the wire can be accomplished by simply rotating the top cover. If the products are sold with the USB-charger wire included, the factory will pre-assemble the USB charger wire inside to save the consumer the time needed to make first setting. As explained in the text boxes included in original FIGS. 7-9, the arrangement means includes an inner shell 49 with a top opening 50. The inner shell 49 has space to load the safety-approved USB charger 51 inside, and includes fixing means for holding the charger in position so that it can be connected to an AC wall outlet and, through prong means and inner circuit means change the AC power from the wall outlet into DC power having a predetermined voltage and current to charge the desired electric or digital devices. The top opening 50 exposes the plug-receiving port or ports of the USB charger so that a plug(s) can be inserted into the port(s). The inner shell 49 is fixed to a base having a notch 52 through which a wire's with a charging plug can pass, and a top cover 48 is rotatably mounted on the inner shell 49. The rotating top cover 48 may be rotated both clockwise and counterclockwise relative to the inner shell 49 and the base 51 to, respectively, cause a wire to be coiled along an outer surface of the inner shell 49 and released from the surface. The surface may or may not include grooves. The wire is coiled from the top down and exits the closed structure formed by the top cover 48 and base 51 through the notch 52. The rotating top cover 48 is capped by a decorative display piece 47 that, for example, allows LED light beams to pass. In the variation shown in FIG. 8, the display piece 47, top cover 55, and base 56 may be the same as shown in FIG. 7, but the USB device of FIG. 8 is constructed with the wire arrangement and inner shell halves 57 being assembled around the USB circuitry, rather than being a pre-manufactured safety-certified unit to which the wire arrangement is added on as in FIG. 7. FIG. 9 shows a similar built-in arrangement with a first decorative or display means 61 with a handle function; a second decorative or display means 62 with a plug receiving opening or recess 67; a rotatable top cover 63; an inner shell 64 in which the USB charger device is loaded, and around with a wire is coiled and released by rotation of the top cover 63; a lower base 65; and a notch for passage of the wire and its plug.

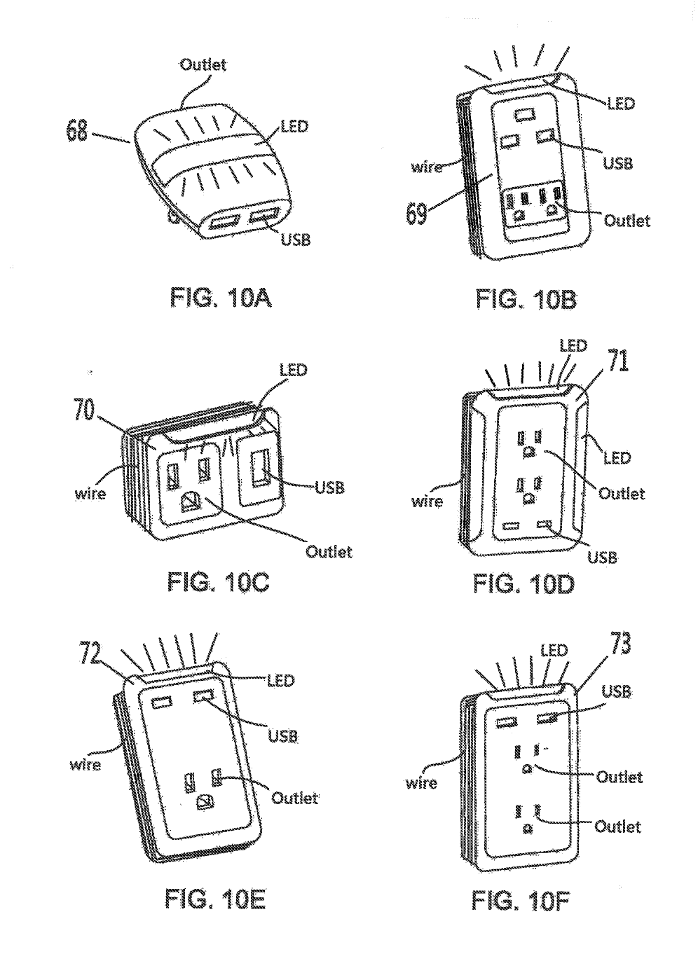

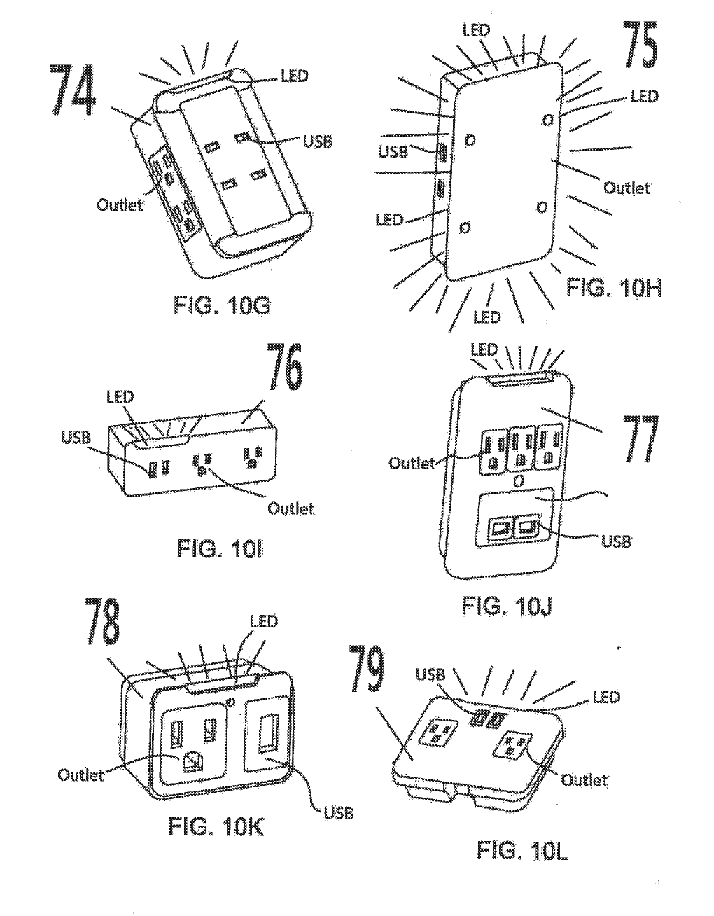

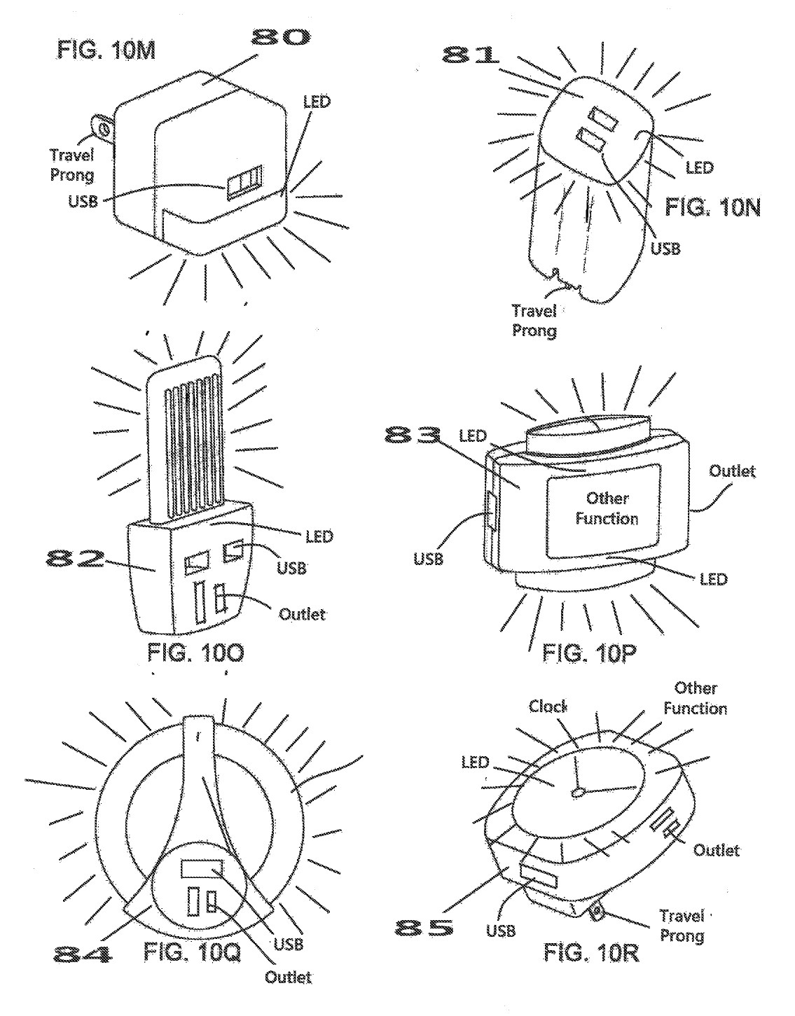

FIGS. 10A-10R a variety of different kinds of USB charger related combinations. It will be appreciated that the invention is not limited to these 18 designs or combinations thereof.

Each of the USB charger related products shown in FIGS. 10A to 10R has at least more than one function so that it will not waste the outlet space of a house.

FIG. 10A shows a USB charger related product with one USB port, one outlet device, one LED light, and a built-in wire arrangement means with a groove in the form of one continuous thread from input to output.

FIG. 10B shows a USB charger related product with three USB ports, two outlets, and LED light, and an add-on silicon wire means extending around the perimeter and along a thickness of the charger related product.

FIG. 10C shows a USB charger related product one USB port and one outlet, and a built-in wire arrangement means in the form of a continuous groove extending around a perimeter and along a thickness of the charger related product.

FIG. 10D shows a USB charger related product with two USB ports and two outlets, and an add-on silicon wire arrangement means extending a perimeter and along a thickness of the charger related product.

FIG. 10E shows a USB charger related product with two USB ports and one outlet device, an LED light, and air freshener with heater means for vaporization, and an add-on wire management means wrapped around the product's thickness.

FIG. 10F shows a USB charger related product with two USB ports and two outlet devices, an LED light, and a built-in wire management means extending beyond the product's thickness because the product is otherwise too thin to accommodate the entire wire length.

FIGS. 10G to 10R show additional USB charger related products to which a wire management means may be added on or built-in:

FIG. 10G shows a USB charger related product with four USB ports and two outlet devices, color changing LED charging indicator, and a night light.

FIG. 10H shows a USB charger related product with four USB ports and a large area color-changing charging-status LED indicator light.

FIG. 10I shows a USB charger related product with two USB ports and two outlet devices, and an LED light.

FIG. 10J shows a USB charger related product with two USB ports and three outlet devices, and a night light.

FIG. 10K shows a USB charger related product with one USB port and one outlet device, and an LED night light.

FIG. 10L shows a USB charger related product with two USB ports and two outlet devices, and an LED night light.

FIGS. 10M and 10N show respective USB chargers with one and two USB ports and two outlet devices, and on which an iPhone™ or iPad™ may be seated.

FIGS. 10O and 10P show respective USB chargers two USB ports and an LED night light device, and on which an iPhone™ or iPad™ may be seated.

FIG. 10Q shows a USB charger related product with a USB port, and LED night light, and space for a phone or tablet on the back.

FIG. 10R shows a USB charger related product with an LED night light, a timepiece device, and space for a phone or tablet on the back.

The USB charger related products of FIGS. 10A to 10R provide a lot of convenient or advantageous or practical functions while eliminating the problem of messy wires hanging from the products to ruin a nice home and lovely accent through the use of the add-on or built-in wire arrangement means of the current invention.

In summary, the current invention has 12 main features or aspects:

1. According to one aspect, the invention provides a wire arrangement means for USB charger related products which includes at least one USB receiving-means to connect with another electric or digital devices' USB plug-means and deliver electric signals from a power source though the USB charger to supply desired electric signals having a certain voltage and current to other electric or digital devices in order to obtain desired functions, performances, and effects. The wire arrangement means includes a groove, ditch, channel, or cut-out to allow the length of the USB-charger wire or other device's wire to be neatly installed when people use the USB charger to charge electric or digital devices. The add-on wire arrangement means may be made of soft and elastic material and is separate from the USB charger or USB charger related products. The soft and elastic material can be wrapped around, surround, attached to, fitted to, adjacent to, or install on the circumference or perimeter of the USB charger or USB charger related products. The wire arrangement means may be in the form of an add-on piece or Build-in piece for the USB charger or USB charger related products. If the wire arrangement means is an add-on wire arrangement means and is a separate piece from the USB charger or USB charger products, then only the USB charger or product need to pass relevant safety standards and obtain safety certification or records or documents. If the wire-arrangement-means is built-into the USB charger or USB charger product, then the entire USB charger or USB charger product including the wire arrangement means needs to pass safety-related tests.

2. If the product is too small, the add-on or built-in wire arrangement means needs to be extended by an amount sufficient to install the whole length of the USB charger's wire, or another device's wire.

3. The add-on arrangement means may be designed to wrap around the perimeter of the USB charger or USB charger products. If the perimeter is large enough, the entire wire length can be accommodated with only a few coils.

4. The USB Charger related products may include, in addition to a USB charger, other devices including at least one outlet device, motion sensor device, time device, remote control device, infrared device, LED light device, integrated circuit device, control device, sensor device, non-LED light device, sensor device, power fail device, color changing status indication devices, controller device, smell device, motion device, audio device, video device, cable TV device, Internet device, or other market-available electric or electronic device.

5. The wire arrangement means may further include at least one holder means to hold only a particular length of the USB-charger's wire, or another device's wire in position.

6. When the add-on wire arrangement means is made of a soft and resilient material, it also offers a shock-absorbing function to protect the USB charger device or USB charger related products upon being dropped on hard surface.

7. The groove, ditch, channel, or cut-outs may be in the form of a continuous screw thread extending from an input end to an output end so that the wire can be easily coiled and released.

8. The groove, ditch, channel, or cutout is preferably deeper than the diameter of the USB charger wire or other wires and accessible by a user's finger to easily remove or release the wire from a hold position.

9. The width of the groove, ditch, channel, or cutouts is preferably smaller than the diameter of the USB charger wire's or other devices' wire's diameter so as to tightly hold the wire in position.

10. The add-on wire arrangement means can be replaced, removed, or separated from the USB charger or USB charger related device as needed.

11. According to another aspect of the invention, an add-on wire arrangement piece for a USB charger or USB charger related products includes at least one wire arrangement means made of a soft and elastic material with grooves, channels, gaps, ditches, or cut-outs that serve as a holding means to hold the USB charger's wire or other device's wire, charger-plug, or USB-plug in a desired position. The USB charger or USB charger related product may incorporate additional devices selected from at least one additional USB charger device, outlet device(s), LED light device, timepiece device, motion sensor device, remote control device, smell device, motion device, animation device, audio device, video device, Internet device, or other electric or electronic device available from the marketplace to become a multi-function product. The add-on wire arrangement means may be a separate piece and can be installed on a USB charger or the USB charger related product that has previously passed safety certification.

12. According to yet another aspect of the invention, a USB charger or USB charger related product has built-in wire arrangement features that include the USB charger or USB charger related product having one or more additional devices selected from at least one additional USB charger device, outlet device, LED light device, timepiece device, motion sensor device, remote control device, smell device, motion device, animation device, audio device, video device, Internet device, digital data device, or other electric or electronic device available from the marketplace to provide a multi-function product. At least one surface, space, construction, or part of the USB charger or USB charger related product is arranged to form grooves, channels, gaps, ditches, or cut-outs to hold the USB charger's or other devices' wire, charger-plug, or USB-plug at a fixed position on the said USB charger or USB charger related product.

I claim:

1. A wire arrangement for an LED light having a USB charger, the USB charger having an outlet side and at least one USB charging port on the outlet side for supplying electric signals having a predetermined voltage and current to other electric or digital devices, comprising:
an add-on or built-in wire arrangement structure that includes a groove, ditch, channel, cut-out, or gap arranged on at least one side, wherein the at least one side is non-parallel with the outlet side, to allow a length of a USB-charger wire or another device's wire to be coiled around an outer circumference or perimeter of the LED light having a USB charge, wherein the wire arrangement structure includes at least one holder arranged to hold at least one end of at least two ends of the wire in position on the USB charger.

2. A wire arrangement for an LED light having a USB charger as claimed in claim 1, wherein the wire arrangement structure is an add-on structure made of an elastic material arranged to install on the outer circumference or perimeter of the USB charger.

3. A wire arrangement for an LED light having a USB charger as claimed in claim 2, wherein the USB charger is a USB charger having its own safety certification, and there is no need for additional safety certification the wire arrangement when added to the USB charger.

4. A wire arrangement for an LED light having a USB charger as claimed in claim 1, wherein the wire arrangement structure is built-into the USB charger while injection molding a housing of the USB charger.

5. A wire arrangement for an LED light having a USB charger as claimed in claim 4, wherein the USB charger is safety certified together with the built-in wire arrangement.

6. A wire arrangement for an LED light having a USB charger as claimed in claim 1, wherein the wire arrangement structure is located around a perimeter of the USB charger.

7. A wire arrangement for an LED light having a USB charger as claimed in claim 1, wherein the wire arrangement for the USB charger is large enough to accommodate an entire length of the wire to be coiled.

8. (A wire arrangement for an LED light having a USB charger as claimed in claim 7, wherein the perimeter of the USB charger is insufficiently large to accommodate an entire length of the wire, and the wire arrangement structure has an enlarged size on an outlet surface that is sufficient to receive a whole wire length by coiling or rolling.

9. (A wire arrangement for an LED light having a USB charger as claimed in claim 1, wherein the LED light includes, in addition to the USB charger, at least one other device selected from at least one outlet device, motion sensor device, time device, remote control device, infrared device, LED light device, integrated circuit device, control device, sensor device, non-LED light device, sensor device, power fail device, color changing status indication devices, controller device, smell device, motion device, audio device, video device, cable TV device, Internet device, or other market-available electric or electronic device.

10. A wire arrangement for an LED light having a USB charger as claimed in claim 1, wherein the at least one holder holds only a partial length or the at least one end of the wire in position on the USB charger.

11. A wire arrangement for an LED light having a USB charger as claimed in claim 1, wherein the wire arrangement structure is made of a resilient material that provides a shock-absorbing function to protect the USB charger from damage upon being dropped on hard surface.

12. A wire arrangement for an LED light having a USB charger as claimed in claim 1, wherein the groove, ditch, channel, or cut-outs and/or the wire arrangement structure is a continuous screw thread extending from an input end to an output end so that the wire can be coiled and released.

13. A wire arrangement for an LED light having a USB charger as claimed in claim 1, wherein the groove, ditch, channel, or cutout is deeper than a diameter of the wire and accessible by a user's finger to remove or release the wire from a held position.

14. A wire arrangement for an LED light having a USB charger as claimed in claim 1, wherein a width of the groove, ditch, channel, or cutout is smaller than a diameter of the wire to tightly hold the wire in position.

15. A wire arrangement for an LED light having a USB charger as claimed in claim 1, wherein the wire arrangement structure is an add-on wire arrangement structure removable and/or detachable from the USB charger related device.

16. A wire arrangement for an LED light having a USB charger, the USB charger or USB charger having an outlet surface and at least one USB port in the outlet surface, comprising:
a wire arrangement structure made of an elastic material with grooves, channels, gaps, ditches, or cut-outs that hold a wire and plug of the USB charger, USB charger, or another device in a desired position, the wire arrangement structure being arranged to be installed as a separate piece and added on at least one outside surface of the USB charger or USB charger,wherein the at least one outside surface is non-parallel with the outlet surface.

17. A wire arrangement for an LED light having a USB charger as claimed in claim 28, wherein the wire arrangement structure is installed on a USB charger or USB charger that has previously passed safety certification.

18. An LED light having a USB charger ports with a built-in wire arrangement, comprising:
at least one wire arrangement structure that receives and holds or coils the wire around a perimeter of the LED light,
wherein LED light incorporates additional devices selected from at least one additional USB charger device, outlet device, LED light device, timepiece device, motion sensor device, remote control device, smell device, motion device, animation device, audio device, video device, Internet device, and other electric or electronic devices available from the marketplace to provide a multi-function product.

19. A wire arrangement for an LED light having a USB charger as claimed in claim 18, wherein the built-in wire arrangement includes grooves, channels, gaps, ditches, or cut-outs to hold the wire, a charger plug, or a USB plug at a fixed position on the USB charger or USB charger.
